(19) United States
(12) Patent Application Publication
(10) Pub. No.: US 2016/0271786 A1
(43) Pub. Date: Sep. 22, 2016

(54) OPTIMIZED SCREWDRIVER HANDLE

(71) Applicant: Michigan Industrial Tools, Inc., Grand Rapids, MI (US)

(72) Inventors: Joshua L. Harrison, Grand Rapids, MI (US); Benjamin E. Harrison, Caledonia, MI (US)

(21) Appl. No.: 14/658,302

(22) Filed: Mar. 16, 2015

(51) Int. Cl. B25G 1/10; B25B 23/16

(52) U.S. Cl. CPC B25G 1/105; B25B 23/16

(57) ABSTRACT

A screwdriver handle configured to provide optimal performance when used in certain handholds to provide high-torque turning with two hands, normal turning with a single hand or low-torque, repetitive turning with two hands. The handle includes a forward zone that is generally circular in cross-section, a central zone that is generally triangular in cross section and has an arrangement of progressive stepped regions and a rear zone that combines a generally cylindrical region with a domed end. The forward zone may in profile follow a shallow somewhat hourglass-like shape. The central zone includes at least two stepped regions that generally increase in diameter toward the rear of the handle. The rear stepped region may be convex having an apex forward of the rear zone. The generally cylindrical region of the rear zone may taper down toward the rear of the handle. The domed end may be a semi-spherical dome.

### BACKGROUND OF THE INVENTION

The present invention relates to hand tools and more particularly to a handle for a screwdriver and other similar tools that are rotated by hand.

Screwdrivers are available with a wide variety of handles. Although many screwdriver handles are designed with the primary goal of providing visual appeal or distinctiveness, the configuration of a screwdriver handle can have a significant impact on the operation of the screwdriver. As a result, a number of screwdriver handles are the result of efforts to improve functional operation. This may include efforts to enhanced comfort, reduce fatigue or improved torque. For example, some screwdrivers are provided with a fluted handle that helps to improve grip for high torque turning. As another example, some screwdriver handles are relatively smooth and therefore facilitate fast repetitive turning of fasteners.

Efforts to provide the ideal screwdriver handle are complicated by the fact that screwdriver handles are typically held differently when performing different tasks. Often, handle features that are helpful for one particular handhold may be problematic for other handholds. The associated complexity is evidenced by the wide variety of screwdrivers handles available on the market today. Although a variety of existing screwdrivers provide improved performance for one handhold or another, there remains a need for a screwdriver handle that provides improved performance across the most commonly used handholds.

### SUMMARY OF THE INVENTION

The present invention provides a screwdriver handle that is configured to provide optimal performance when used in high-torque turning with two hands, in normal turning with one hand or in two-hand low-torque, repetitive turning. The screwdriver handle of the present invention includes at least three distinct regions arranged in a unique configuration. The screwdriver handle generally includes a forward zone that is generally circular in cross-section, a central zone that is triangular in cross section and has an arrangement of progressive steps and a rear zone that combines a generally cylindrical region with a domed end.

In one embodiment, the forward zone is generally circular in cross-section and varies smoothly in diameter along the longitudinal extent of the screwdriver handle. The diameter of the forward zone may be smallest at a point inward from the opposite longitudinal ends and may increase smoothly toward opposite longitudinal ends. For example, the forward zone may in profile follow a shallow hourglass-like shape. The forward zone may be generally smooth to allow the handle to be easily spun between fingers holding the handle loosely in the forward zone.

In one embodiment, the central zone includes at least two steps that generally increase in diameter toward the rear of the handle. The central zone may, in cross-section, be generally triangular with three somewhat linear peripheral segments joined by three rounded corner segments. The rounded corner segments may be generally circular in cross-section and share a common center at the central axis of the screwdriver, such that the corner segments are segments of a common circle spaced radially about the handle. The generally linear regions of the central zone may be somewhat concave, and may define three somewhat concave planar sections disposed in a triangular configuration about the central axis of the screwdriver. The first stepped region may have an inclined section through which the diameter generally increases toward the rear and a plateau section through which the diameter remains somewhat constant or decreases toward the rear. Similarly, the second step region may have an inclined section through which the diameter generally increases and a plateau section through which the diameter remains somewhat constant or decreases toward the rear. In one embodiment, the plateau section of the first stepped region remains substantially constant in diameter and the plateau section of the second stepped region decreases toward the rear of the handle. In use, the central zone is intended to be gripped by a single hand for high torque turning.

In one embodiment, the rear zone combines a generally cylindrical region with a domed end. The generally cylindrical region is circular in cross-section, but may vary somewhat in diameter along its longitudinal length. For example, the cylindrical region may taper down toward the rear of the handle. The diameter of the cylindrical region may be greatest at the forward end and may decrease smoothly toward the rear end. The cylindrical region may be generally smooth about its circumference to allow it to be easily spun by the fingers. The domed end may be positioned immediately rearward of the cylindrical region to constitute the rearward termination of the handle. The domed end may be a semi-spherical dome that provides a surface for applying significant forward force to the screwdriver. For example, the heel or palm of the rearward hand may engage the domed end to push the screwdriver forwardly into the screw during high-torque turning.

In one embodiment, the forward zone, central zone and rear zone are arranged immediately adjacent to one another with no intervening zones. The handle may include smooth transitions from forward zone to central zone and from central zone to rear zone. For example, the diameter of the forward zone at its rearmost extent may correspond with the diameter of the forward-most extent of the central zone, and the diameter of the central zone at its rearmost extent may correspond with the diameter of the forward-most extent of the rear zone.

In one embodiment, the handle includes a quillon and the forward zone begins immediately rearwardly of a quillon. In the illustrated embodiment, the quillon may have a cross-section with a plurality of linear peripheral segments. The quillon may be generally triangular in cross-section having three linear peripheral segments joined by three rounded corner segments. The rounded corner segments may be generally circular in cross-section and share a common center at the central axis of the screwdriver, such that the corner segments are segments of a common circle spaced radially about the handle. The forward end of the quillon may be generally flat and the rearward end of the quillon may transition smoothly to the forward zone.

The present invention provides a screwdriver handle with contours that help to position the fingers naturally and comfortably on the driver handle when used in several common handholds, thereby reducing fatigue and increasing torque. The concave areas being positioned around the axis and on the long sides of the triangular cross section of the handle shape reduce hand fatigue by providing a surface to press against to generate torque preventing the hand from slipping around the handle in high torque applications especially in situations where hands or tools might be covered in oil. This is different from many drivers which rely on grip pressure combined with the friction between the handle surface and skin of the hand which can cause injury. The cylindrical areas allow the driver to be spun quickly and with repetition for tasks such as installing machine screws with fine threads. The location of the high torque area and the cylindrical areas to each other and the handle as a whole contribute to its function. The handle is designed to fit and work with the human hand and to function with the most common and natural methods for gripping a screwdriver handle.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a top, front, right perspective view of a screwdriver incorporating a handle in accordance with an embodiment of the present invention.

FIG. 2 is a bottom, rear, left perspective view of the screwdriver.

FIG. 3 is a right side elevational view of the screwdriver.

FIG. 4 is a top view of the screwdriver.

FIG. 5 is a bottom view of the screwdriver.

FIG. 6 is a front view of the screwdriver.

FIG. 7 is a rear view of the screwdriver.

FIG. 8 is a segmented view of the screwdriver handle.

FIGS. 9A-E are sectional views of the screwdriver handle taken along lines shown in FIG. 3.

FIG. 10 is a schematic representation of the cross sectional shape of the corner segments of the central zone.

FIG. 11 is an illustration showing the screwdriver used in a two-handed, low-torque spinning operation.

FIG. 12 is an illustration showing the screwdriver used in a one-handed normal turning operation.

FIG. 13 is an illustration showing the screwdriver used in a two-handed, high-torque turning operation.

FIG. 14A is a bottom view of the screwdriver handle.

FIG. 14B is a sectional view of the screwdriver handle taken along line C-C of FIG. 14A.

FIG. 14C is an enlarged view of area D of FIG. 14B.

### DESCRIPTION OF THE CURRENT EMBODIMENT

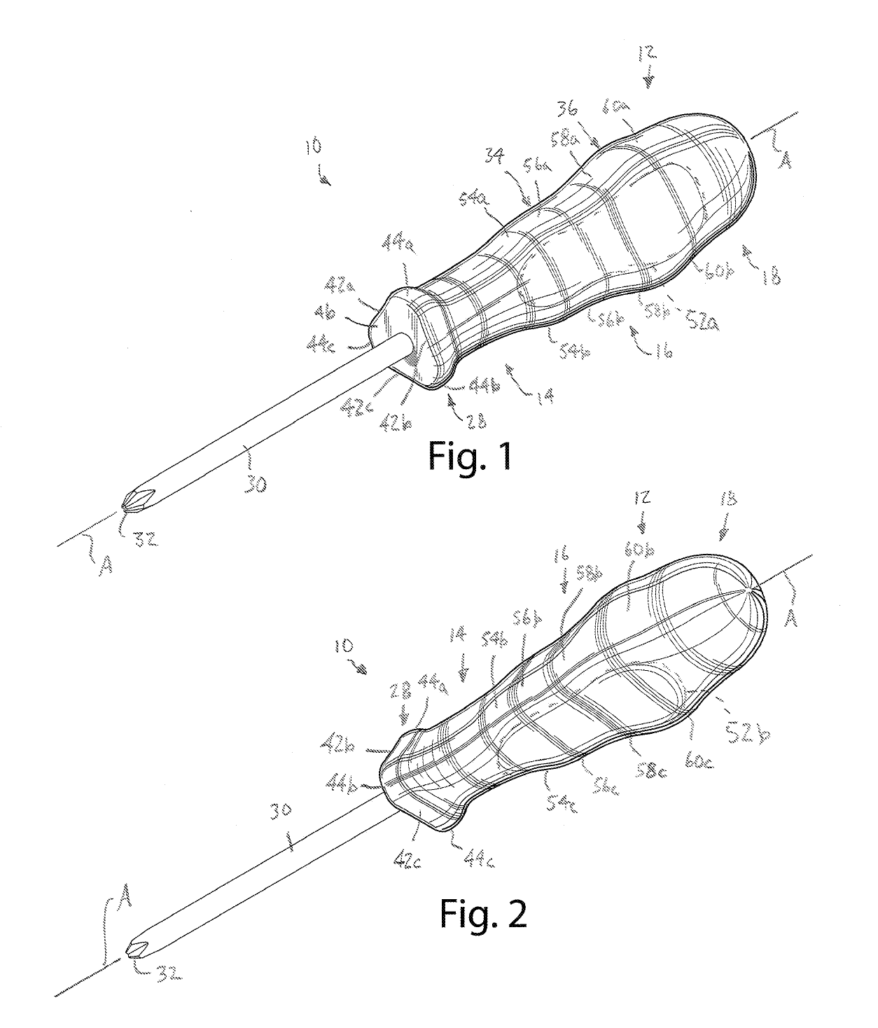

A screwdriver 10 having a handle 12 in accordance with an embodiment of the present invention is shown in FIGS. 1-13. The screwdriver handle 12 generally includes a forward zone 14, a central zone 16 and a rear zone 18. In this embodiment, the forward zone 14 is generally circular in cross-section and provides a smooth region that can be easily spun within loosely gripping fingers. The central zone 16 is generally triangular in cross-section and includes two progressively stepped regions 34 and 36. The configuration of the central zone 16 is ideal for gripping the screwdriver handle 12 during normal turning and high torque turning. The rear zone 18 generally includes a cylindrical region 38 and a domed end 40. The cylindrical region 38 has a relatively large diameter and provides an ideal structure for spinning the screwdriver 10 during low-torque turning operations. The domed end 40 provides a structure against which a forward force can be readily applied to the screwdriver 10, for example, during high-torque turning operations. The screwdriver handle 12 may also include a quillon 28 positioned at the forward end of the forward zone 14.

The present invention is described in the context of a handle for a screwdriver with a Phillips tip. It should be understood that the present invention may be incorporated into screwdrivers with other types of drive tips, such as slotted (regular), Torx, hex socket, hexagon external, clutch, fluted socket, tri-wing, square socket, square external, spanner drilled and spanner slotted. The handle may also be incorporated into other hand tools that might be used for low-torque turning and high-torque turning. Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. Further, the term “forward” is used to refer to a direction parallel to the central axis of the screwdriver in which the tip of the screwdriver is pointed and the terms “rear” and “rearward” are used to refer to a direction opposite the direction in which the tip of the screwdriver is pointed. The use of directional terms should not be interpreted to limit the invention to any specific orientation(s).

Although there are a wide variety of ways to hold a screwdriver, it has been determined that screwdriver handles are typically held differently when used for different purposes. For example, it has been determined that there are three different positions that are used most commonly depending on the application. Screwdriver handles are typically held one way for normal turning with one hand, a different way for high-torque turning with two hands and yet another way for low-torque, repetitive turning with two hands. The present invention provides a screwdriver handle that is specially configured to provide optimal performance when used in normal turning with one hand, high-torque turning with two hands or low-torque, repetitive turning with two hands.

Referring now to FIGS. 1 and 2, the screwdriver 10 generally includes a shaft 30 with a tip 32. In this embodiment, the shaft 30 is a rod-like structure having rear end (not shown) that is received in the handle 12 and a forward end that defines the tip 32. The shaft 30 may have a central axis A. The rear end of the shaft 30 may include a head (not shown) or other structure that helps to prevent relative rotation between the handle 12 and the shaft 30. For example, the rear end of the shaft 30 may be stamped to create a portion with a non-circular cross-sectional shape that is capable of interlocking with mating features inside the handle 12. The illustrated shaft 30 is merely exemplary and may vary from application to application. For example, the length, diameter and shape of the shaft 30 may vary. In the illustrated embodiment, the tip 32 is configured to drive a Phillips head screw (not shown). As noted above, the tip 32 may vary from application to application to interface with different types of screws, bolts and other fasteners, or to interface with rotatably driven tools, such as drill bits or sockets. The handle 12 may be fitted to the shaft 30 using any suitable techniques or apparatus. For example, the handle 12 may be direct-molded in place directly on the shaft 30. Alternatively, the handle 12 may be manufactured separate from the shaft 30, and then the handle 12 may be fitted onto the rear end of the shaft 30. In applications in which the handle 12 and shaft 30 are separately manufactured, the handle 12 and shaft 30 may be intersecured by cement, epoxy or other adhesives. Additionally or alternatively, the handle 12 and shaft 30 may be intersecured by friction and/or by fasteners, such as a locking pin (not shown).

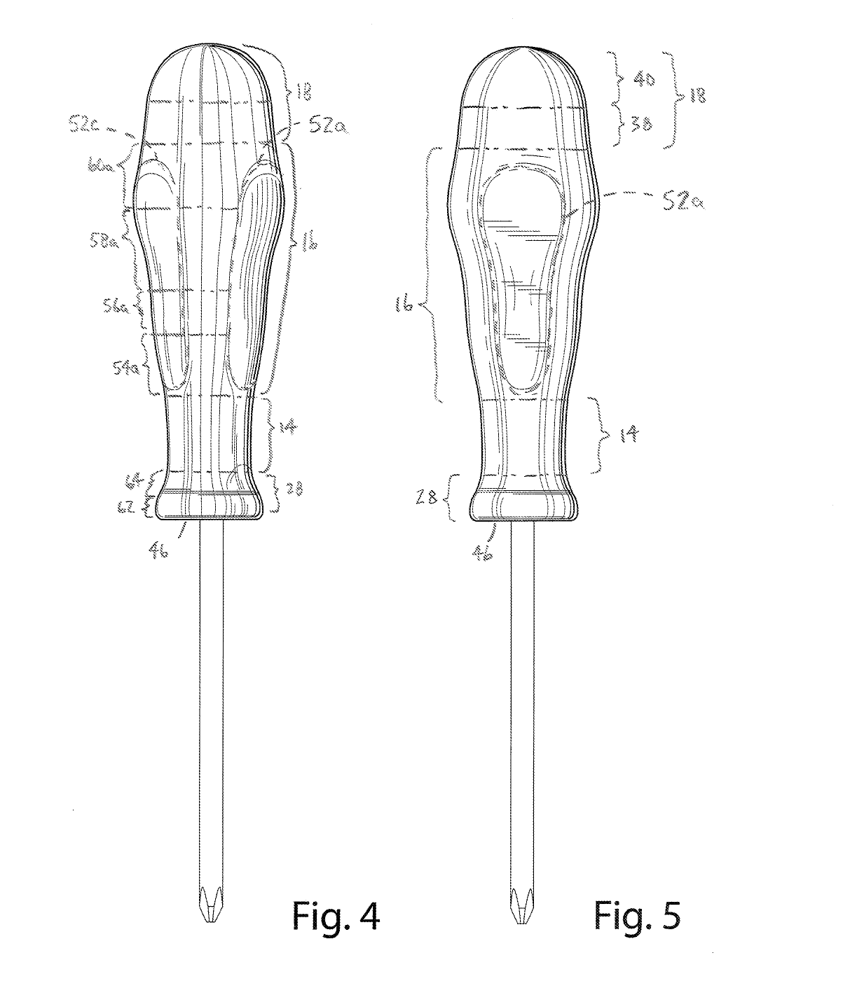

As perhaps best shown in FIGS. 4-6, the handle 12 of the illustrated embodiment has a longitudinal extent and is disposed concentrically about the shaft 30. The screwdriver handle 12 generally includes a quillon 28, a forward zone 14 that is generally circular in cross-section, a central zone 16 that is generally triangular in cross-section and has an arrangement of progressive stepped regions 34, 36 and a rear zone 18 that combines a generally cylindrical region 38 with a domed end 40. FIG. 8 is an illustration of the handle 12 separated into the quillon 28, the forward zone 14, the central zone 16 and the rear zone 18. In FIG. 8, the rear zone 18 is further separated into cylindrical zone 38 and domed end 40 (described in more detail below).

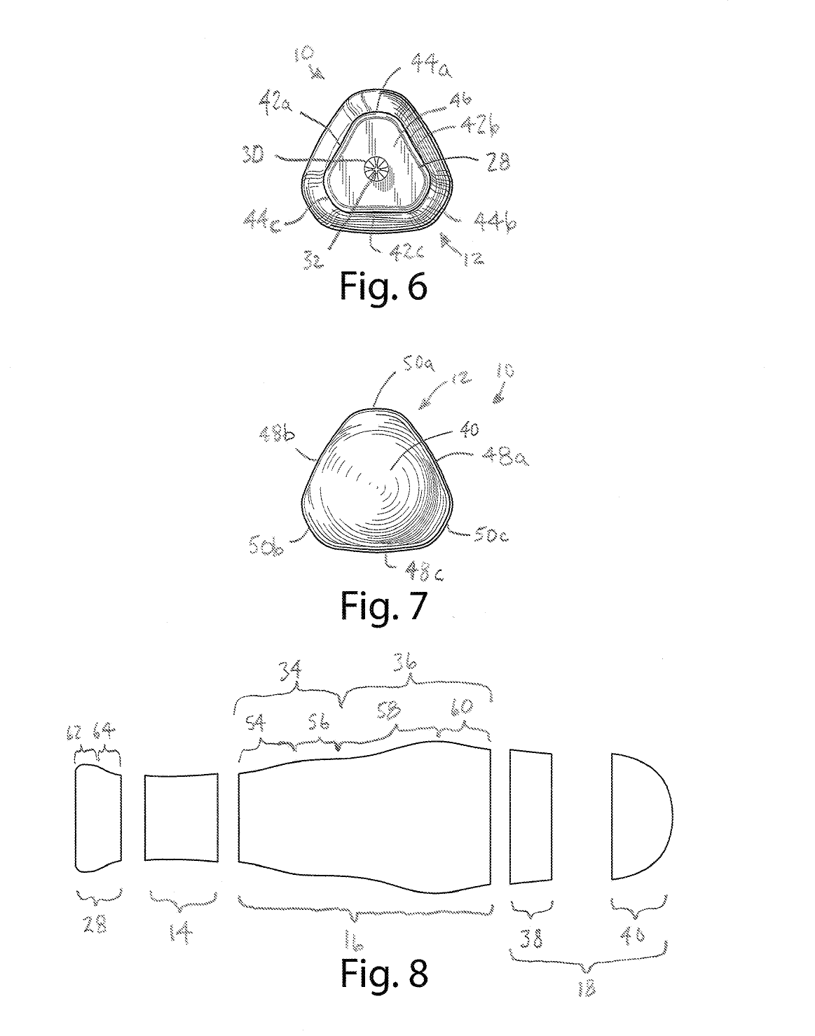

In the illustrated embodiment, the handle 12 includes a quillon 28 at the forward-most end. The quillon 28 of this embodiment is generally triangular in cross-section having three linear peripheral segments 42a-c joined by three rounded corner segments 44a-c. As perhaps best shown in FIG. 6, the linear segments 42a-c and corner segments 44a-c may alternate in a radially symmetric pattern about the central axis of the handle 12. The rounded corner segments 44a-c may be generally circular in cross-section and share a common center at the central axis of the screwdriver handle 12, such that the corner segments 44a-c are segments of a common circle. Although the respective sizes of the linear segments 42a-c and corner segments 44a-c may vary, in the illustrated embodiment, each linear segment 42a-c occupies about 80 degrees and each corner segment 44a-c occupies about 40 degrees. In the illustrated embodiment, the quillon 28 includes a forward end 46 facing toward the tip 32. The forward end 46 of the quillon 28 is generally flat in the illustrated embodiment, but its shape may vary. The illustrated quillon 28 includes a forward section 62 and a rear section 64. As perhaps best shown in FIGS. 4 and 8, the corner segments 44a-c of the forward section 62 are generally convex in the longitudinal direction and generally concave in rear section 64. The rear section 64 transitions smoothly into the forward zone 14. The illustrated quillon 28 is merely exemplary. The quillon 28 may vary in size, shape and configuration from application to application, and may be eliminated, when desired.

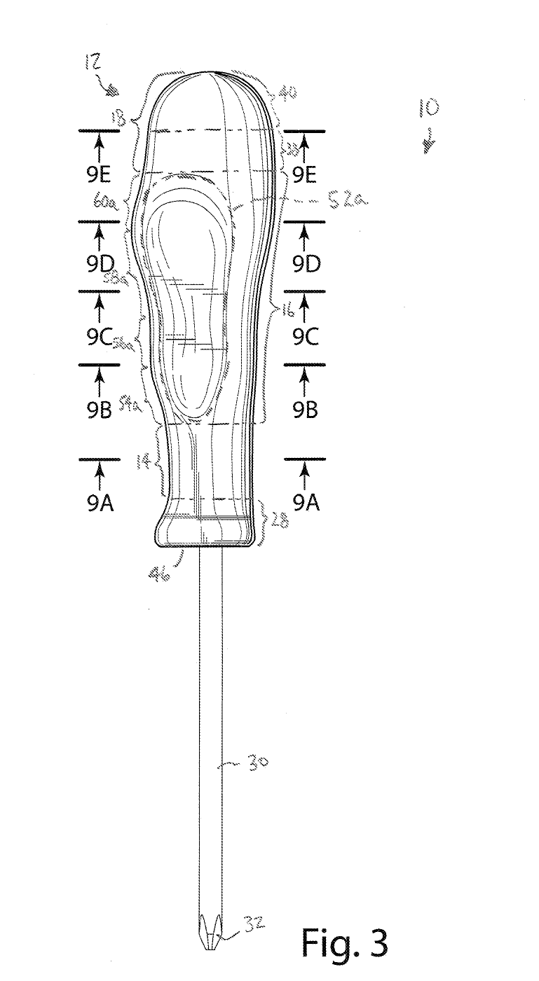

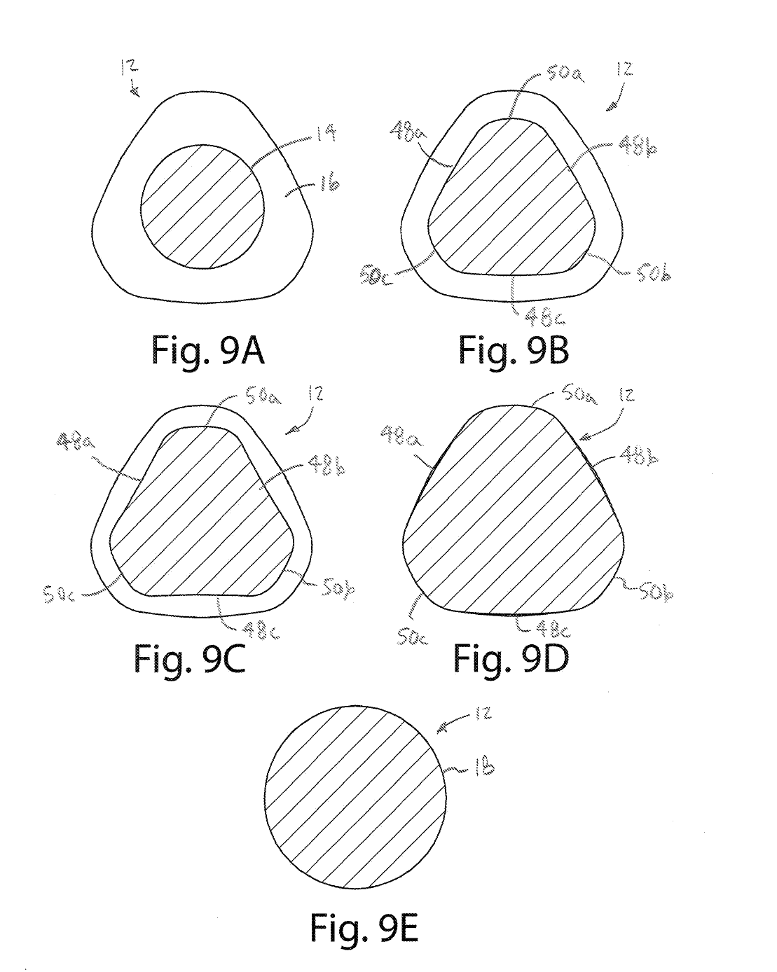

Referring now to FIGS. 3, 5 and 8, the forward zone 14 is positioned immediately adjacent to and rearward of the quillon 28. The forward zone 14 of the illustrated embodiment is generally circular in cross-section and provides a smooth spinning region that allows the handle 12 to be easily spun between fingers loosely gripping the forward zone 14 (See FIG. 9A and 11). The forward zone 14 may be cylindrical or it may vary in diameter along its longitudinal extent. For example, the forward zone 14 may, in profile, follow a shallow hourglass-like shape. In some embodiments, the hourglass-like shape may exist only in those portions of the forward zone 14 that are longitudinally aligned with the corner segments 44a-c of the quillon 28 where the diameter of the handle 12 is transitioning downwardly from the peak diameter of the corner segments 44a-c. In those portions of the forward zone 14 that are longitudinally aligned with the linear segments 42a-c of the quillon 28, the variation in diameter from the quillon 28 to the forward zone 14 may result in little or no concavity (See FIG. 3). The hourglass-like shape may be asymmetrical with the smallest diameter being closer to the forward end and increasing gradually and smoothly in diameter toward opposite ends. The extent of concavity in the forward zone 14 may vary from application to application. When included, this concavity may help to center the user's fingers on the forward zone 14 and provide an inclined surface against which force may be applied when urging the screwdriver 10 forward, for example, into a screw head (not shown). The concavity of the forward zone 14 smoothly merges with the shape of the quillon 28 so that they cooperatively provide a larger bearing surface.

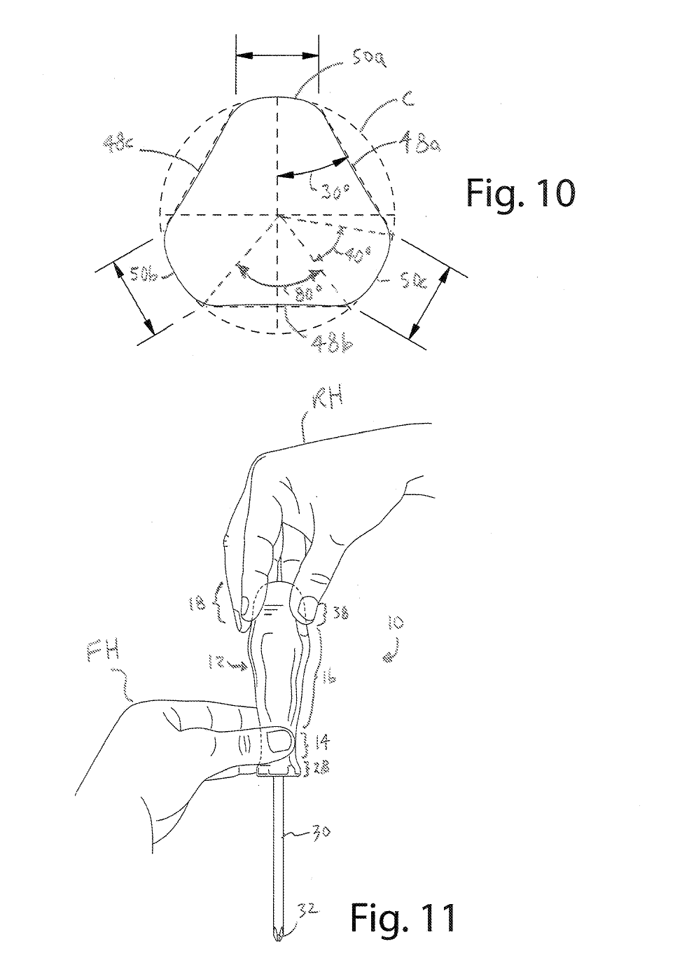

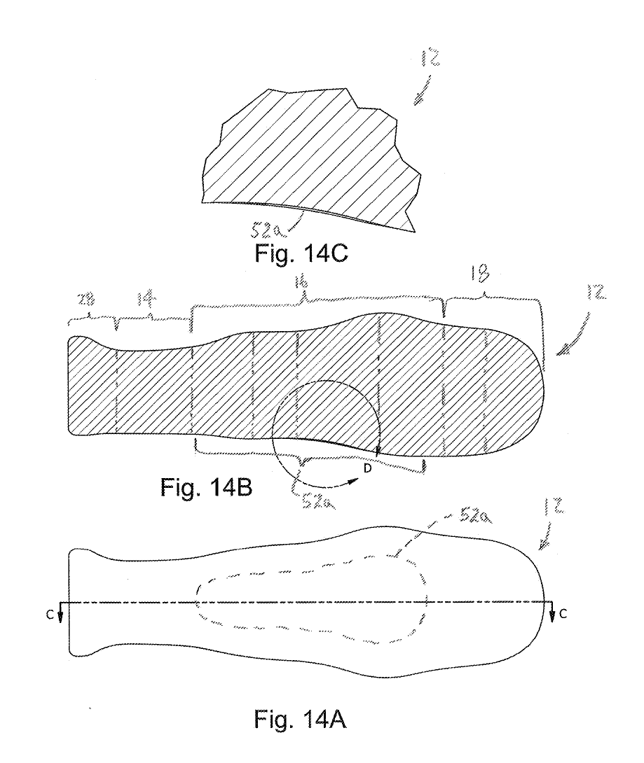

As noted above, the central zone 16 is positioned immediately adjacent to and rearward of the forward zone 14. The central zone 16 is generally triangular in cross section and includes at least two stepped regions 34, 36 that generally increase in diameter toward the rear of the handle 12 (See FIG. 8). The central zone 16 is configured to allow the handle 12 to be firmly gripped with a single hand and to provide a high degree of leverage useful in the development of high-torque. When viewed in cross-section, the peripheral shape of the central zone 16 of FIG. 9B-9D and 10 generally includes three somewhat linear segments 48a-c joined by three rounded corner segments 50a-c. The shape of the generally linear segments 48a-c of the central zone 16 may vary along the longitudinal extent of the central zone 16. In the illustrated embodiment, the linear segments 48a-c vary from generally straight on opposite end to somewhat concave through the middle region. This may best be seen by comparing FIGS. 9B-9D, which are cross sections taken at different locations along the central zone 16 as indicated by the corresponding reference lines in FIG. 3. As a result of the change in shape of the linear segments 48a-c, the central zone 16 of this embodiment includes three somewhat concave planar regions 52a-c disposed in a triangular configuration about the central axis of the handle 12. The contours of regions 52a-c are complex and perhaps best illustrated in the various sectional views shown in FIGS. 9B, 9C, 9D, 14B and 14C. In the illustrated embodiment, each concave planar region 52a-c includes some concavity in the lateral direction and some concavity in the longitudinal direction. For example, FIG. 14C is an enlarged view of a portion of concave planar region 52a showing concavity in the lateral direction. Referring now to FIG. 14B, the forward portion of each concave planar regions 52a-c is inclined (albeit only slightly in the illustrated embodiment) to provide an angled bearing surface against which force can be applied in the forward direction. The angle of incline in the forward portion may vary from application to application as desired. Although the corner segments 50a-c may vary in shape from application to application, the corner segments 50a-c of the illustrated embodiment are generally circular in cross-section and share a common center at the central axis of the screwdriver, such that when view in cross-section the corner segments 50a-c represent three radially spaced segments of a common circle (See FIG. 10). The relative circumferential sizes of the linear segments 48a-c and corner segments 50a-c may vary from application to application. However, as shown in FIG. 10, in the illustrated embodiment, each linear segment 48a-c occupies about 80 degrees of the circumferential extent and each corner segment 50a-c occupies about 40 degrees of the circumferential extent. As perhaps best shown in FIG. 3, each corner segment 50a-c varies in diameter along the longitudinal extent of the central zone 16 to define the first stepped region 34 and the second stepped region 36. The first stepped region 34 begins at the forward end of the central zone 16 and has an inclined section 54a-c through which the diameter generally increases toward the rear and a plateau section 56a-c through which the diameter remains generally constant or decreases toward the rear. In the illustrated embodiment, the diameter of the plateau section 56a-c of the first stepped region 34 remains substantially constant through its longitudinal extent. Similarly, the second stepped region 36 has an inclined section 58a-c through which the diameter generally increases and a plateau section 60a-c through which the diameter remains somewhat constant or decreases toward the rear. In the illustrated embodiment, the plateau section 60a-c is convex along its longitudinal extent having an apex forward from the rear zone 18. The precise size, shape and configuration of the central zone 16 may vary from application with departing from the present invention.

Referring now to FIGS. 3, 5 and 8, the rear zone 18 of the illustrated embodiment includes a generally cylindrical region 38 and a domed end 40. The generally cylindrical region 38 is circular in cross-section (See FIG. 9E), but may vary somewhat in diameter along its longitudinal length. For example, the cylindrical region 38 may, in profile, follow a shallow taper toward the rear. As perhaps best shown in FIG. 8, the diameter of the cylindrical region 38 may be greatest at the forward end and may decrease smoothly toward the rear end of the cylindrical region. The cylindrical region 38 may be generally smooth around its circumference to allow it to be easily spun by the fingers. In the illustrated embodiment, the domed end 40 is positioned immediately rearward of the cylindrical region 38 and constitutes the rear termination of the handle 12. Referring again to FIG. 8, the domed end 40 of this embodiment is a semi-spherical dome. In use, the dome provides a large, comfortable surface for applying significant forward force to the screwdriver 10. For example, the heel or palm of the rearward hand may be placed against the domed end 40 to allow that hand to apply force in the forward direction to push the screwdriver 10 into the screw during high-torque turning.

In the illustrated embodiment, the forward zone 14, central zone 16 and rear zone 18 are disposed immediately adjacent to one another with no intervening zones. Further, the handle 12 includes smooth transitions from forward zone 14 to central zone 16 and from central zone 16 to rear zone 18. For example, the diameter of the forward zone 14 at its rearmost extent may correspond with the diameter of the forward-most extent of the central zone 16, and the diameter of the central zone 16 at its rearmost extent may correspond with the diameter of the forward-most extent of the rear zone 18.

The present invention provides a screwdriver handle 12 that is optimized for use in two-handed low-torque spinning, in one-handed normal turning and in two-handed high torque turning. When used in low-torque spinning, the forward zone 14 and the rear zone 18 may be used in concert to allow the driver 10 to be spun quickly and with repetition. This may be particularly useful with repetitive tasks that require limited torque, such as installing machine screws with fine threads. For example, as shown in FIG. 11, the forward zone 14 may be loosely held between the thumb and at least one finger of the forward hand FH while the fingers of the rearward hand RH grab and spin the screwdriver 10 using the cylindrical region 38 of the rear zone 18. The smooth circular configuration of the forward zone 14 allows the screwdriver handle 12 to easily spin within the relatively loose fingers of the forward hand FH. The somewhat hourglass-shaped profile of the forward zone 14 also helps to improve comfort and performance. For example, the hourglass shape helps to center the fingers of the forward hand FH in the forward zone 14 and provides an inclined surface against which the fingers of the forward hand FH can more easily apply a force in the forward direction to maintain engagement between the screwdriver 10 and the screw. The cylindrical region 38 has a relatively large diameter, which typically makes it easier for the fingers of the rearward hand RH to grip the handle 12 and rotate the screwdriver 10.

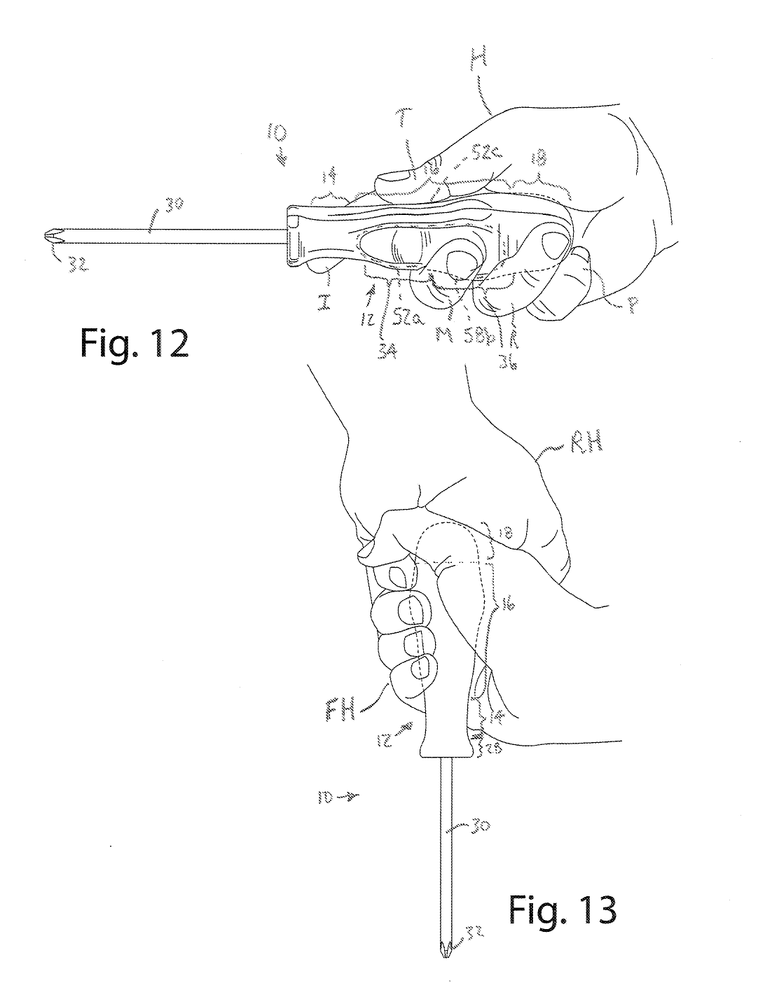

FIG. 12 shows the screwdriver 10 being used for normal one-handed turning. When using the screwdriver for normal turning, it may be held by a single hand H wrapped primarily around the central zone 16. The hand H may be positioned with the middle finger M wrapped around the inclined section 58b of the second stepped region 36 with the fingertip positioned in the concave planar region 52a, the ring finger R wrapped around the apex of the second stepped region 36 with the fingertip positioned in the rear zone 18, the pinky finger P positioned behind the domed end 40. Further, the thumb T is positioned in general alignment with the central axis of the handle 12 along a concave planar region 52c with the heel of the thumb engaging the rear zone 18 and the tip segment of the thumb positioned in concave planar region 52c. Finally, the index finger I extends generally forwardly from the hand with fingertip positioned in the forward zone 14 and potentially engaging the quillon 28. During normal one-handed turning, the structure of the handle 12 not only facilitates the application of significant torque, but also the application of force in a forward direction to maintain engagement between the screwdriver tip 32 and a screw. For example, the tip of the thumb T is seated in concave planar region 52c and can bear against the inclined surface at the forward end of concave planar region 52c when applying forward force. Further, the middle finger M and the ring finger R may be positioned to straddle the apex of the second stepped region 36, which allows the ring finger R to bear against the inclined surface rearward of the apex of the second stepped region 36 when applying forward force.

When using the screwdriver for high torque turning, it may be held with the forward hand FH wrapped around the central zone 16 and the rear hand RH engaging the domed end 40 of the rear zone 18. This handhold is achieved by holding the handle 12 in an orientation substantially perpendicular to the longitudinal extent of the forward hand FH. Referring now to FIG. 13, the forward hand FH may be wrapped around the central zone 16 with all four fingers wrapped around the triangular cross section so that the fingertips are positioned in concave planar region 52a. In this position, the knuckles allow the fingers to wrap around corner segments 50a-c in such a way as to allow the corner segments 50a-c to function as lever-like structures that can be firmly engaged by the forward hand FH. When use of a rear hand RH is desired, the palm or heel of the second hand can be applied to the domed end 40 of the handle to apply force in the forward direction. This may help to maintain intimate engagement between the tip 32 of the screwdriver 10 and the head of the screw.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A screwdriver handle having a forward end, a rearward end and a central axis comprising:
a forward zone having a longitudinal extent, said forward zone being generally circular in cross-section throughout said forward zone longitudinal extent and having a center generally coincident with the central axis of the handle;
a central zone having a longitudinal extent, said central zone being disposed rearward of said forward zone, said central zone being generally triangular in cross-section throughout said central zone longitudinal extent with three generally linear peripheral segments joined by three rounded corner segments, said corner segments varying in diameter along said central zone longitudinal extent of said central zone to define first and second stepped regions, said first stepped region having an inclined section through which said diameter generally increases toward the rearward end and a plateau section through which said diameter remains generally constant or decreases toward the rearward end, said second stepped region having an inclined section through which said diameter generally increases toward the rearward end and a plateau section through which said diameter remains generally constant or decreases toward the rearward end; and
a rear zone having a longitudinal extent, said rear zone being disposed rearward of said central zone, said rear zone including a generally cylindrical region extending through a forward portion of said rear zone longitudinal extent and a domed end extending through a rearward portion of said rear zone longitudinal extent, said generally cylindrical region being generally circular in cross-section with a center generally coincident with the central axis of the handle.

2. The screwdriver handle of claim 1 wherein said forward zone is concave along said forward zone longitudinal extent, said forward zone having a middle region and opposed end regions, said end regions having a greater diameter than said middle region.

3. The screwdriver handle of claim 2 wherein said rounded corner segments are generally circular in cross-section and share a common center, said common center being substantially coincident with the central axis of the screwdriver.

4. The screwdriver handle of claim 3 wherein said generally linear regions of said central zone are concave, whereby said central zone includes three concave planar sections disposed in a triangular configuration.

5. The screwdriver handle of claim 4 wherein said domed end is generally semi-spherical.

6. The screwdriver handle of claim 5 further including a quillon disposed forwardly of said forward zone, said quillon having a longitudinal extent, said quillon being generally triangular in cross-section throughout said quillon longitudinal extent.

7. The screwdriver handle of claim 6 wherein said quillon has a rear diameter corresponding with a forward diameter of said forward zone, said forward zone has a rear diameter corresponding with a forward diameter of said central zone, said central zone has a rear diameter corresponding with a forward diameter of said cylindrical region, said cylindrical region has a rear diameter corresponding with a forward diameter of said domed end.

8. A screwdriver handle comprising a longitudinally extended body having a first end, a second end and a central axis, said body having a first zone that is generally circular in cross-section and has a center generally coincident with said central axis, said body having a second zone immediately adjacent to said first zone, said second zone being generally triangular in cross-section with three generally linear peripheral segments joined by three rounded corner segments, said corner segments varying in diameter to define a first stepped region and a second stepped region, each of said first stepped region and said second stepped region having an inclined section through which said diameter generally increases toward said second end and a plateau section through which said diameter remains generally constant or decreases toward said second end, said body including a third zone disposed immediately adjacent to said second zone, said third zone being generally cylindrical and having a center generally coincident with said central axis, said body including a domed end disposed at said second end immediately adjacent to said third zone.

9. The screwdriver handle of claim 8 wherein said rounded corner segments are generally circular in cross-section and share a common center, said common center being substantially coincident with said central axis.

10. The screwdriver handle of claim 9 wherein said generally linear regions of said second zone are concave, whereby said second zone includes three concave planar sections disposed in a triangular configuration.

11. The screwdriver handle of claim 10 wherein said domed end is generally semi-spherical.

12. The screwdriver handle of claim 11 wherein said first zone is concave having a middle region and opposed end regions, said end regions having a greater diameter than said middle region.

13. The screwdriver handle of claim 12 further including a quillon disposed at said first end of said body, said quillon having a longitudinal extent, said quillon being generally triangular in cross-section.

14. The screwdriver handle of claim 13 wherein said quillon, said first zone, said second zone, said third zone and said domed end are disposed immediately adjacent one another in a row from said first end to said second end.

15. A screwdriver handle comprising:
a quillon having a generally triangular cross section centered on a central axis of the handle;
a first spinning zone disposed adjacent to said quillon, said first spinning zone having a longitudinal extent and a generally circular cross section centered on the central axis of the handle;
a gripping zone disposed adjacent to said first spinning zone, said gripping zone having a longitudinal extent and a generally triangular cross section centered on the central axis of the handle, said gripping zone having a first stepped section and a second stepped section, said second stepped section being greater in diameter than said first stepped section, said gripping zone including three convex regions and three concave regions alternating in a radially symmetric pattern about the central axis of the handle;
a second spinning zone disposed adjacent to said gripping zone, said second spinning zone having a longitudinal extent and a generally circular cross section centered on the central axis of the handle, said second spinning zone having a diameter substantially greater than said first spinning zone; and
a domed end disposed adjacent to said second spinning zone, said domed end being generally circular in cross section and having a generally semi-spherical shape centered on the central axis of the handle.

16. The screwdriver handle of claim 15 wherein said first spinning zone is concave along said first spinning zone longitudinal extent.

17. The screwdriver handle of claim 16 wherein said quillon is longitudinally divided into a convex first section and a concave second section.
